(19) United States
(12) Patent Application Publication
(10) Pub. No.: US 2026/0216689 A1
(43) Pub. Date: Jul. 30, 2026

(54) METHOD FOR PRODUCING GRANULATED LDH SORBENT

(71) Applicants: OOO "ECOSTAR-NAUTECH, Novosibirsk (RU); OOO "Irkutsk Oil Company", Irkutsk (RU)

(72) Inventors: ALEKSANDR VIKTOROVICH LETUEV, Novosibirsk (RU); GRIGORII MIKHAILOVICH ZABORTSEV, Novosibirsk (RU); ALEKSANDR DMITRIYEVICH RIABTSEV, Novosibirsk (RU); VALERII IVANOVICH TITARENKO, Novosibirsk (RU)

(21) Appl. No.: 19/143,424

(22) PCT Filed: Dec. 27, 2023
(86) PCT No.: PCT/RU2023/000402

§ 371 Date: Jun. 26, 2025

(30) Foreign Application Priority Data
Dec. 30, 2022 (RU) 2022135356

(51) Int. Cl. B01J 20/04; B01J 20/30

(52) U.S. Cl. CPC B01J 20/046; B01J 20/3028; B01J 20/3042; B01J 2220/4806

(57) ABSTRACT

Method for producing granulated lithium aluminum double hydroxide chloride (LDH) sorbent includes feeding a metered amount of LDH powder and a binder into a mixer-granulator. After mixing and the addition of a binder solvent, the following are performed: granulation of the LDH sorbent, air and vacuum degassing of the LDH sorbent, and unloading and screening of the resulting granules. A low-boiling-point chlorocarbon solvent is used as the binder solvent. The binder solvent is recovered by condensation, with a flow of an air-steam mixture being directed through the following loop: mixer-granulator—dust filtration—condensation of the binder solvent—heating of the air-steam mixture—mixer-granulator. Granulation of the LDH sorbent is carried out with the air-steam mixture in the mixer-granulator at 30-40° C. and the air-steam mixture circulating at flow rate of 200-300 h⁻¹. The method reduces the costs of granulating the LDH sorbent and recovering the binder solvent during granulation.

### FIELD OF THE INVENTION

This invention pertains to chemical materials science, particularly to methods for granulating inorganic sorbents made from aluminum hydroxide, which selectively extract lithium from natural brines and synthetic lithium-containing chloride salt solutions.

### CONVENTIONAL ART

In international practice, an inorganic sorbent made from a hydrated composite material with the composition LiCl/Al(OH)₃ (see U.S. Pat. No. 6,280,693) has been suggested for selectively extracting lithium from brines [1].

A method is known for producing a granulated sorbent for extracting lithium from brine (Russian Federation Patent No. 2009714) by granulating a granulated lithium aluminum double hydroxide chloride (LDH) sorbent with a defective structure, using fluoroplastic as a binder and acetone as a solvent [2].

A disadvantage of this method is using fluoroplastic as a binder, which dissolves in acetone. The use of acetone makes the granulation process susceptible to explosions and fires, requiring appropriate safety measures.

A method is known for producing a granular sorbent to extract lithium from solutions containing lithium (Russian Federation Patent No. 2455063). The method includes obtaining a chlorine-containing type of double aluminum and lithium hydroxide (LiCl·2Al(OH)₃·nH₂O), followed by drying, grinding, and granulating the powder with polyvinyl chloride and methylene chloride as a solvent, while recovering the methylene chloride that evaporates during granulation and returning it to the process [3].

The method's drawbacks include:
elevated residual solvent levels in the extrudate, resulting in higher solvent usage and deteriorated sanitary and hygienic conditions in production;
reduced mechanical strength of the initial LDH granules produced by crushing degassed extrudate because of their irregular shape;
methylene chloride recovery system, which relies on oil absorption-desorption of its vapors and subsequent condensation into the liquid phase, is not only cumbersome and challenging to operate, but also poses a fire hazard because of the simultaneous use of a large volume of combustible material in the form of vacuum oil.

A recognized technique for manufacturing high-strength spherical ceramic granules (Russian Federation Patent No. 2133716) includes granulating crushed raw materials through pelletizing in a disc granulator [4]. The drawback of the technique is its multi-stage process and complexity in implementation.

A recognized technique for producing granulated sorbent for lithium extraction from lithium-containing brines (Russian Federation Patent No. 2657495) includes obtaining a powder of double aluminum and lithium hydroxide (LDH), separating LDH powder from the solution, drying, grinding the powder to a particle size <0.10 mm, granulating the powder with the addition of chlorinated polyvinyl chloride and an organochlorine solvent by preparing a paste from dried and ground LDH powder and a fresh solution of chlorinated polyvinyl chloride in an organochlorine solvent, extruding the paste through dies, degassing the extrudate with a heated air stream, vacuum degassing, crushing and sizing the extrudate, drum pelletizing and packaging of the finished granules, compressing and pre-cooling the air stream saturated with organochlorine solvent vapors with separation of the condensed phase, and advanced cooling of the air stream for advanced condensation of the organochlorine solvent [5]. This method was selected as the prototype of the claimed invention.

The disadvantages of the method are:
prolonged mixing of the paste to achieve uniform distribution of dried and ground LDH powder;
a multi-stage process for producing LDH sorbent granules (extrusion—two-stage degassing—crushing—pelletizing);
high costs for treating the degassing air stream, which is heated (up to 120-130° C.) to degas the extrudate and then subjected to stepwise advanced cooling (down to −15° C.) to condense the organochlorine solvent;
compression of the vapor-and-air stream to reduce gas volume;
presence of a large amount of water (in solid and liquid form) in the condensate, which requires phase separation and might alter the properties of the solvent (e.g., methylene chloride) due to hydrolysis.

The objective of the invention is to reduce the cost of granulating LDH sorbent and recovering the binder solvent during granulation.

### DETAILED DESCRIPTION OF EMBODIMENTS OF THE INVENTION

Reference will now be made in detail to the preferred embodiments of the present invention.

The objectives are achieved by implementing the proposed method for producing granulated LDH sorbent, in which granulation is performed using a mixer-granulator with a rotor that creates a vortex field of material particles and vapor-and-air mixture inside the mixer-granulator body; LDH powder, binder, and measured binder solvent is mixed in the mixer-granulator body; air and vacuum degassing of the resulting granulated LDH sorbent are performed sequentially in the mixer-granulator body; the binder solvent is metered after mixing the LDH powder and binder in the mixer-granulator body; air degassing of LDH sorbent is performed in the mixer-granulator body while rotating the body and rotor; air degassing is performed after dosing the binder solvent into the mixer-granulator body; air degassing is performed simultaneously with LDH sorbent granulation; air degassing of LDH sorbent is carried out by circulating the vapor-and-air mixture in a closed circuit: mixer-granulator body—binder solvent condensation—vapor-and-air mixture heating—mixer-granulator body; condensation of the binder solvent is preceded by filtration of the vapor-and-air mixture from LDH sorbent dust; vacuum degassing of LDH sorbent is performed after air degassing, with the mixer-granulator body rotating and at a residual pressure of 0.1 atm in the body; LDH sorbent is granulated at a vapor-and-air mixture temperature in the mixer-granulator body of 30-40° C. and a vapor-and-air mixture circulation rate of 200-300 h⁻¹.

Using a rotating mixer-granulator with a high-speed rotor intensifies the granule formation process by creating a vortex field of powder material particles and vapor-and-gas mixture inside the mixer-granulator body. The mixer-granulator performs several functions: intensive mixing of the initial components, sorbent granulation, and removal of the binder solvent from the sorbent granules.

The air degassing process occurs in a closed loop of circulating vapor-and-gas mixture: mixer-granulator—aerosol filter—heat recuperator—methylene chloride vapor condenser—vapor-and-gas mixture heater—mixer-granulator.

Air degassing of the granulated LDH sorbent in the mixer-granulator body reduces the volume of vapor-and-air mixture entering condensation during removal of the binder solvent from LDH sorbent compared to the prototype (Russian Federation Patent No. 2657495).

At the end of the air degassing process, vacuum degassing of the granulated LDH sorbent is performed with the rotating mixer-granulator body at a residual pressure of 0.1 atm.

The sorbent granules from the granulator are sieved and the target fraction (granules in the range of 0.5-3.0 mm) is separated.

The remaining recycle sorbent granules (with granule sizes less than 0.5 mm and greater than 3.0 mm) can be sent back to the mixer-granulator for reprocessing.

Mixing the LDH powder and binder, as well as dosing the binder solvent in the mixer-granulator body with the rotating body and rotor create an intense vortex field that first quickly achieves high mixture homogeneity, and then, upon dosing the binder solvent, rapidly produces a homogeneous paste for subsequent sorbent granule formation.

Using a low-boiling organochlorine solvent as the binder solvent enables effective degassing of the granules without significant heating of the vapor-and-air mixture.

Dosing the binder solvent into the mixer-granulator body after the mixing of LDH powder and binder ensures contact of the solvent with the fresh homogeneous mixture.

Simultaneous granulation and degassing of LDH sorbent reduces the time required to produce the sorbent due to the specifics of the LDH sorbent production process using a binder, which requires removal of the binder solvent from the resulting granules.

Circulating the vapor-and-air mixture in a closed circuit: mixer-granulator body—dust filtration—binder solvent condensation—vapor-and-air mixture heating—mixer-granulator body, during LDH sorbent degassing first removes binder solvent vapors from the sorbent surface, then the sorbent dust from the vapor-and-air mixture stream preventing fouling of the heat exchange surfaces with sorbent deposits, extracts solvent vapor from the vapor-and-air mixture by condensation, and removes the solvent from the system, and heats the solvent-depleted vapor-and-air mixture, stabilizing the temperature during sorbent degassing, since evaporation of the low-boiling binder solvent is accompanied by a decrease in the sorbent surface temperature. Circulating the vapor-and-air mixture in a closed circuit increases the concentration of solvent vapor, which improves the efficiency of condensation by reducing the volume of the vapor-and-air mixture.

Granulation of LDH sorbent in the mixer-granulator at a vapor-and-air mixture temperature of 30-40° C. and a vapor-and-air mixture circulation rate of 200-300 h⁻¹ yields target fraction sorbent granules in an amount of 65-70% of the mass of the loaded LDH powder, binder, and recycle mixture.

The volumetric rate of circulation of the vapor-and-air mixture (h⁻¹) is defined as the ratio of the flow rate of the circulating vapor-and-air mixture (m³/h) against the volume of the mixer-granulator body (m³), and it characterizes the gas exchange in the mixer-granulator body.

The achievement of the technical result is confirmed by an example of the method for producing granulated LDH sorbent.

### List of Tables:

Table 1. Characteristics of the vortex mixer-granulator.
Table 2. Process parameters for LDH sorbent granules in the mixer-granulator.
Table 3. Particle-size distribution of the resulting LDH sorbent granules.
Table 4. Output of target fraction of granules and recycle in the mixer-granulator.

### EXAMPLE

Clumps of synthesized LDH were crushed using a CW-60C+ grinder and fractionated on sieves. LDH granules smaller than 100 m were used.

The setup for producing LDH sorbent granules included a vortex mixer-granulator, aerosol filter, rotameters, condenser, condensate drum, circulation pump, gas heater, and cryostat. Characteristics of the mixer-granulator are shown in Table 1.

TABLE 1
Characteristics of the vortex granulator-mixer

| Characteristics | Values | |
|---|---|---|
| Type | OVP (pelletizing, | |
| | vortex, batch) | |
| Mode of operation | batch | |
| Body volume | 6 | L |
| Rotational speed of the body | 70 | rpm |
| Rotor speed | 0-3,000 | rpm |

| | |
|---|---|
| Powder loading | maximum 1 kg |

The vortex mixer-granulator operated in a batch mode. The calculated amount of LDH powder and chlorinated polyvinyl chloride resin was loaded through a hatch into the mixer-granulator body. Next, the aerosol filter was installed on the mixer-granulator.

When starting the mixer-granulator, the body was rotated first, followed by the rotor. The rotor speed was set using a frequency converter in the control unit. The rotational speed of the mixer-granulator body was constant at 70 rpm. Due to the rotation of the body and rotor (which rotate in opposite directions), an intense vortex of the loaded material was created along the bottom and wall of the body. The mixing time was 5 minutes.

Then, the required amount of binder solvent for granulation was introduced into the mixer-granulator body through the liquid phase supply unit, with methylene chloride—a low-boiling organochlorine solvent—used as the binder solvent.

Methylene chloride entered the moving layer of material, where repeated collisions of moistened particles with each other, with mixing elements, and with the body walls, during the distillation of methylene chloride in the vortex field, resulted in the formation of the required spherical sorbent granules.

Since methylene chloride is an expensive reagent, it was recovered by condensation on a cooled surface.

Air degassing of granules (methylene chloride distillation) was carried out simultaneously with granule formation. For this, with the body and rotor rotating, the air circulation pump was turned on, creating a vacuum at the suction pipe, which drew the vapor-and-air mixture from the mixer-granulator body into the methylene chloride condensation system, and overpressure at the supply pipe, which returned the gas flow to the mixer-granulator body.

From the mixer-granulator body, the vapor-and-air mixture containing suspended LDH sorbent particles and methylene chloride vapors entered the aerosol filter, where LDH sorbent dust particles were separated.

Next, the vapor-and-air mixture was sent to the condenser, where it was cooled and methylene chloride was condensed on a surface cooled by liquid (TOSOL-40) from the cryostat.

The mixture of condensed methylene chloride and residual gases entered the condensate receiver, where phase separation occurred. To reduce methylene chloride losses, the condensate drum was cooled with TOSOL-40 from the cryostat.

Then, the vapor-and-air mixture was fed to the inlet of the air circulation pump, and from the outlet to the vapor-and-air mixture heater, where it was heated to 30° C. and then fed into the mixer-granulator body.

Circulation of the vapor-and-air mixture in the closed circuit: mixer-granulator body—dust filtration—binder solvent condensation—vapor-and-air mixture heating—mixer-granulator body, enabled recovery of methylene chloride used to produce LDHsorbent granules from its powder.

At the end of the air degassing process (methylene chloride distillation), the rotation of the mixer-granulator rotor was stopped, and vacuum degassing was performed with the mixer-granulator body rotating at a residual pressure of 0.1 atm, after which the material was unloaded. The unloaded material was fractionated using a set of sieves.

Process characteristics for LDH sorbent granules in several experiments are presented in Table 2.

TABLE 2
Process parameters for LDH sorbent granules in the mixer-granulator.

| | Weight of | LDH | Weight of | MX | Mixing | MX feed | Time for granule |
|---|---|---|---|---|---|---|---|
| Exp. | LDH powder | powder | binder | volume, | time, | time, | formation and |
| # | batch, g | size, um | batch, g | ml | min | min | MX removal, min |
| 1 | 460 | >100 | 40 | 350 | 5 | 2 | 12 |
| 2 | 460 | >100 | 40 | 350 | 5 | 2 | 10 |
| 3 | 460 | 100-160 | 40 | 350 | 5 | 2 | 11 |
| 4 | 460 | 160-250 | 40 | 350 | 5 | 2 | 11 |

Table 3 shows the particle-size distribution of LDH sorbent produced in the mixer-granulator.

TABLE 3
Particle-size distribution of the resulting LDH sorbent granules.

| | Granule weight | | | | | | | | | |
|---|---|---|---|---|---|---|---|---|---|---|
| Exp. | Particle | Sieves, mm | | | | | | | | |
| # | size | 10 | 7 | 5 | 3 | 2 | 1 | 0.5 | 0.0 | Σ |
| 1 | g | 0.3 | 0.5 | 0.7 | 3.7 | 11.7 | 100 | 127.1 | 46.3 | 290.3 |
| | % | 0.103 | 0.172 | 0.241 | 1.275 | 4.03 | 34.45 | 43.78 | 15.95 | 100.0 |
| 2 | g | 11.5 | 1.4 | 3.1 | 12.2 | 30.2 | 191.4 | 92.3 | 25.4 | 367.5 |
| | % | 3.129 | 0.381 | 0.844 | 3.32 | 8.218 | 52.08 | 25.12 | 6.912 | 100.0 |
| 3 | g | 1.1 | 0.8 | 2 | 7 | 16.2 | 119.9 | 145 | 76.7 | 368.7 |
| | % | 0.298 | 0.217 | 0.542 | 1.899 | 4.394 | 32.52 | 39.33 | 20.8 | 100.0 |
| 4 | g | 2.4 | 0.9 | 1.3 | 6 | 16.4 | 175 | 79.2 | 56.5 | 337.7 |
| | % | 0.711 | 0.267 | 0.385 | 1.777 | 4.856 | 51.82 | 23.45 | 16.73 | 100.0 |

Based on Table 3, the yield of the target granule fraction and recycle in the mixer-granulator was calculated. The calculation results are presented in Table 4.

TABLE 4
Output of target fraction of granules and recycle in the mixer-granulator.

| | Total | Target granule fraction | | Recyle | |
|---|---|---|---|---|---|
| Exp. | mass of | (0.5-3 mm) | | (>3 mm and <0.5 mm) | |
| # | granules, g | g | % wt | g | % wt |
| 1 | 290.3 | 238.8 | 82.26 | 51.5 | 17.74 |
| 2 | 367.5 | 313.9 | 85.41 | 53.6 | 14.59 |
| 3 | 368.7 | 281.1 | 76.24 | 87.6 | 23.76 |
| 4 | 337.7 | 270.6 | 76.24 | 67.1 | 19.87 |

When implementing the claimed method for producing granulated LDH sorbent in the mixer-granulator, the observed yield of conditioned granules is more than 76% wt.

To test the sorption properties of the resulting granulated LDH sorbent according to the method, a simulated brine similar in composition to the brine of Lake Qarhan (g/dm³) was used: LiCl 3.71; MgCl₂ −450.

The exchange capacity of sorbents produced using calcium hydroxide as the alkaline agent is practically identical to the exchange capacity values of LDH sorbent samples produced according to the prototype.

It should also be appreciated that various modifications, adaptations, and alternative embodiments thereof may be made within the scope and spirit of the present invention. The invention is further defined by the following claims.

### REFERENCES (ALL INCORPORATED HEREIN IN THEIR ENTIRETY)

1. U.S. Pat. No. 6,280,693 C01D 15/00. Composition for the recovery of lithium values from brine and process of making/using said composition/William C. Bauman John L. Burba. Filed on 20 Sep. 1996, published on 28 Aug. 2001.
2. Russian Federation Pat. No. 2009714. B 01 J 20/00. Process of manufacturing pelletized sorbing material for lithium recovery from salt brines/Menzheres L. T., Kotsupalo N. P., Orlova L. B., Isupov V. P. Filed on 27.01.92, published on 30 Mar. 1994. Bulletin No. 9.
3. Russian Federation Pat. 2455063. B 01 J 20/30, B 01 J 20/02. Method of producing granular sorbent for extracting lithium from lithium-containing brine/Rjabtsev A. D. Titarenko, N. P. Kotsupalo et al. Filed on 13 Oct. 2010, published on 10 Jul. 2012. Bulletin No. 19.
4. Russian Federation Pat. No. 2133716. C04B 20/04, 20/10, 35/16, E 21 B 43/267. Method for producing high-strength spherical ceramic pellets/Migal V. P., Mozhzherin V. A., Novikov A. N. et al. Filed on 10 Nov. 1997, published on 27 Jul. 1999. Bulletin No. 21.
5. Russian Federation Pat. No. 2657495. B 01 J 20/30, B 01 J 20/02, B 01 J 20/08. Method for obtaining a granular sorbent for lithium recovery from lithium-containing brines under conditions of production of commercial lithium products/Rjabtsev A. D. Titarenko, N. P. Kotsupalo et al. Filed on 25 Sep. 2017, published on 14 Jun. 2018. Bulletin No. 17.

What is claimed is:

1. A method for producing a granulated lithium aluminum double hydroxide chloride (LDH) sorbent, the method comprising the steps of:
introducing, for granulation, an LDH powder and a binder into a mixer-granulator with a rotor that creates a vortex field of material particles and a vapor-and-air mixture inside the mixer-granulator body;
mixing the LDH powder and the binder;
introducing binder solvent into the mixer-granulator;
mixing the LDH power, the binder and the binder solvent;
air and vacuum degassing of the granulated LDH sorbent;
sieving of the resulting LDH sorbent granules; and
recovering the binder solvent by condensation from the mixer-granulator.

2. The method of claim 1, wherein the binder solvent is introduced after the mixing of the LDH powder and the binder in the mixer-granulator body.

3. The method of claim 1, wherein the air degassing of the LDH sorbent is carried out in the mixer-granulator while both the mixer-granulator and the rotor are rotating.

4. The method of claim 3, wherein the air degassing of the LDH sorbent is performed after the introduction of the binder solvent into the mixer-granulator.

5. The method of claim 3, wherein the air degassing of the LDH sorbent is performed simultaneously with the granulation of the LDH sorbent.

6. The method of claim 3, wherein the air degassing of the LDH sorbent is performed by circulating the vapor-and-air mixture in a closed circuit: the mixer-granulator—condensation of binder solvent—heating of vapor-and-air mixture—mixer-granulator.

7. The method of claim 6, wherein the condensation of the binder solvent is preceded by filtration of the vapor-and-air mixture to remove LDH sorbent dust.

8. The method of claim 1, wherein the vacuum degassing of the LDH sorbent is performed after the air degassing, with the mixer-granulator rotating and a residual pressure in the mixer-granulator of 0.1 atm.

9. The method of claim 1, wherein the LDH sorbent is granulated at a vapor-and-air mixture temperature in the mixer-granulator of 30-40° C. and a vapor-and-air mixture circulation rate of 200-300 h⁻¹.
